(19) United States
(12) Patent Application Publication
(10) Pub. No.: US 2017/0336653 A1
(43) Pub. Date: Nov. 23, 2017

(54) Systems and Methods Involving Single Vision and Multifocal Lenses for Inhibiting Myopia Progression

(71) Applicant: Brien Holden Vision Institute, Sydney, New South Wales (AU)

(72) Inventor: Ravi Chandra Bakaraju, Kingsford, New South Wales (AU)

(73) Assignee: Brien Holden Vision Institute, Sydney, New South Wales (AU)

(21) Appl. No.: 15/523,267

(22) PCT Filed: Nov. 4, 2015
(86) PCT No.: PCT/AU2015/050690

§ 371 Date: Apr. 28, 2017

Related U.S. Application Data
(60) Provisional application No. 62/075,553, filed on Nov. 5, 2014.

(51) Int. Cl. G02C 7/02

(52) U.S. Cl. CPC G02C 7/02; G02C 2202/24

(57) ABSTRACT

A corrective lens system for the eyes of an individual includes first and second pairs of lenses of first and second prescriptions, respectively. In certain embodiments, the first pair of lenses includes a first lens for the left eye and a first lens for the right eye, and the second pair of lenses includes a second lens for the left eye and a second lens for the right eye. The first and second pairs of lenses may be configured in package having a plurality of compartments with individual lenses disposed in individual compartments. A set of instructions may be provided for wearing the first pair of lenses for a first time period and the second pair of lenses for a second time period. The first prescription is different from the second prescription. The lenses may inhibit the progression of myopia in the individual. Methods of arranging, prescribing, and using the lens system are described.

This application claims the benefit of U.S. Provisional Patent Application No. 62/075,553 filed Nov. 5, 2014, the entire contents of which are incorporated herein by reference.

### REFERENCES

The following references are incorporated by reference herein in their entirety: U.S. Pat. No. 7,025,460 entitled Methods and apparatuses for altering relative curvature of field and positions of peripheral, off-axis focal positions, U.S. Pat. No. 7,503,655 entitled Methods and apparatuses for altering relative curvature of field and positions of peripheral, off-axis focal positions, U.S. Pat. No. 7,997,727 entitled Method and apparatus for controlling peripheral image position for reducing progression of myopia, International Publication No. WO2013/149303 entitled Lenses, devices, methods, and systems for refractive error, and International Publication No. WO2014/059465 entitled Lenses, devices, methods, and systems for refractive error.

### FIELD OF THE DISCLOSURE

The present disclosure relates generally to methods and systems for correcting the refractive error of the eye. More particularly, the present disclosure relates to methods and systems for exercising the eye and inhibiting/controlling the progression of myopia using a regimen of wearable ophthalmic lenses such as contact lenses.

### BACKGROUND

Refractive error, an optical state of the eye in which the focus of the eye is incorrect causing blurred vision, includes myopia (near sightedness or shortsightedness), hyperopia (farsightedness or longsightedness) and/or astigmatism. In myopia, the optical focus defect is such that distant objects (items in the scenery being viewed by the eye) appear blurred because their images are focused in front of the retina, instead of being focused on the retina.

Refraction by the eye can be “ametropic,” i.e., a state of being incorrectly focused (for which the eye may be myopic, hyperopic and/or astigmatic). An ametropic state or condition is the opposite of “emmetropic,” which is a state of correct focusing by the eye. The present inventors have observed that the central regions of the eye and the peripheral regions of the eye can have different refractive states. For example, with or without a corrective lens in place, an eye may have a correctly focused central image point (i.e., corrected to emmetropia centrally), but may still have peripheral image points that are out of focus (i.e., left to be ametropic peripherally). In other examples (without being exhaustive), with or without a corrective lens in place, an eye may be centrally hyperopic and peripherally myopic, centrally hyperopic and peripherally emmetropic, centrally hyperopic and peripherally even more hyperopic, centrally myopic and peripherally myopic, centrally myopic and peripherally emmetropic, centrally myopic and peripherally hyperopic, etc.

In yet another example, again without being exhaustive, with or without a corrective lens in place, an eye may have on-axis retinal image quality that increases in the direction of eye growth and off-axis retinal image quality that also increases in the direction of, eye growth, on-axis retinal image quality that decreases in the direction of eye decreases in the direction of the eye growth or off-axis retinal image quality that decreases in the direction of eye growth, on-axis retinal image quality that decreases in the direction of eye growth and/or off-axis retinal image quality that remains relatively constant in the direction of eye growth, on-axis retinal image quality that remains relatively constant in the direction of eye growth and/or off-axis retinal image quality decreases in the direction of the eye growth, on-axis retinal image quality that increases in the direction of eye growth and/or off-axis retinal image quality that increases in the direction of eye growth.

Myopia is a common visual disorder, affecting around a quarter of the adult population of the USA. In some countries, most notably in the east-Asian region, the prevalence of myopia is about 80% in school-age children. Today, a large percentage of the world's population has significant levels of myopia that requires some form of optical correction. It is also known that myopia progresses, in some individuals, regardless of age of onset, and that this increase in myopia not only requires those individuals to wear stronger correction, but also considerably high magnitudes of myopia (>−6.00 D) often predisposes the myopic individuals to some degree of pathology of the eye. In the recent years, high myopia has been associated with increased risk of retinal detachment, posterior cataract and glaucoma. In addition, this visual disorder may be accompanied by personal, social and financial burdens to the individual and to the community. These include the direct costs of vision correction and management (which may amount to several billion dollars a year), as well as indirect costs such as productivity and quality of life.

Various methods have been employed in an attempt to slow the progression of myopia. One such method is the method of under-correction. This method has a drawback of providing constant blurred vision for distance viewing. Another method known in the field is the utilization of conventional bifocal or multifocal lenses that have monotonic power variations across the optics of the lens that contribute towards distinct correction for near, intermediate and distance viewing conditions.

The above-noted methods that attempt to slow the progression of myopia are on-axis methods of myopia control, in the sense that they involve manipulation and/or control of optical defocus in the straight-ahead, on-axis, direction toward the fovea. Other approaches for inhibiting the progression of myopia involve manipulation and control of optical defocus that impact a peripheral region outside the fovea by manipulating the positions of peripheral (i.e., off-axis) image points, or the relative curvature of field of the visual image.

The present inventors have observed that approaches disclosed in the art for addressing myopia may fall short in one or more ways of serving the combined needs of a person to be able to wear effective myopia control lenses and yet be able to function effectively during the day in various activities that a person may typically undertake. Accordingly, systems and methods for solving these and other problems disclosed herein become desirable. The present disclosure is directed to overcome and/or ameliorate at least one of the disadvantages of the prior art as will become apparent from the discussion herein.

### SUMMARY

The present disclosure is directed to the ongoing need for enhanced systems and methods for choosing wearable and appropriate lenses that may inhibit the progression of myopic eyes while providing reasonable vision to the person during a number of typical activities that a person may undertake during a typical day. Various aspects of the present disclosure may address such needs.

According to certain embodiments, a method for choosing corrective lenses for an individual is described. The method comprises obtaining eye measurement information for a person based on at least one measurement of the person's eyes; identifying a first prescription for a first pair of lenses for the person based on, at least in part, the eye measurement information of the person, the first pair of lenses comprising a first lens for the left eye and a first lens for the right eye; identifying a second prescription for a second pair of lenses for the person based on, at least in part, the eye measurement information of the person, the second pair of lenses comprising a second lens for the left eye and a second lens for the right eye; identifying a first time period for the person to wear the first pair of lenses; and identifying a second time period for the person to wear the second pair of lenses, wherein the first prescription is different from the second prescription. In certain embodiments, the method may further comprise the step of providing instructions for the person for wearing the first pair of lenses of the first prescription for the first time period and the second pair of lenses of the second prescription for the second time period.

Other embodiments are directed to a method of manufacturing a corrective lens kit. The method comprises selecting a first pair of lenses of a first prescription, the first pair of lenses comprising a first lens for the left eye and a first lens for the right eye; selecting a second pair of lenses of a second prescription, the second pair of lenses comprising a second lens for the left eye and a second lens for the right eye; packaging the first pair of lenses and the second pair of lenses together into a package of lenses comprising a plurality of compartments formed by a base and removable cover portions, an individual lens of the first and second pairs of lenses being disposed in an individual compartment in a sterile solution, a given removable cover portion being adapted to permit exposing a given lens individually without impairing a compartment of another lens; and providing a set of written instructions for wearing the first pair of lenses of the first prescription for a first time period and the second pair of lenses of the second prescription for a second time period, wherein the first prescription is different from the second prescription.

Other embodiments are directed to a corrective lens system for the eyes of an individual. The system comprises a first pair of lenses of a first prescription, the first pair of lenses comprising a first lens for the left eye and a first lens for the right eye; a second pair of lenses of a second prescription, the second pair of lenses comprising a second lens for the left eye and a second lens for the right eye; the first pair and second pair of lenses being arranged in package comprising a plurality of compartments formed by a base and removable cover portions, an individual lens of the first and second pairs of lenses being disposed in an individual compartment in a sterile solution, a given removable cover portion adapted to permit exposing a given lens individually without impairing the compartment for another lens; and a set of written instructions for wearing the first pair of lenses of the first prescription for a first time period and the second pair of lenses of the second prescription for a second time period, wherein the first prescription is different from the second prescription.

Other embodiments are directed to a method of affecting the vision of, or exercising, the eyes of an individual. The method comprises wearing a pair of lenses of a first prescription proximate to a left eye and a right eye for a first time period, the pair of lenses of the first prescription comprising a first lens for the left eye and a first lens for the right eye; thereafter, wearing a pair of lenses of a second prescription proximate to the left eye and the right eye for a second time period, the second prescription being different from the first prescription, the pair of lenses of the second prescription comprising a second lens for the left eye and a second lens for the right eye; thereafter, wearing a pair of lenses of the first prescription proximate to the left eye and the right eye for another first time period; and thereafter, wearing a pair of lenses of the second prescription proximate to the left eye and the right eye for another second time period.

As well as the embodiments discussed in the summary, other embodiments are disclosed in the specification, drawings and claims.

### DETAILED DESCRIPTION OF THE DRAWINGS

To further clarify various aspects of certain embodiments, a more particular description of certain embodiments is provided by references to specific embodiments thereof, which are illustrated in the appended drawings. These drawings depict exemplary embodiments and are therefore not to be considered limiting of its scope. The exemplary embodiments are described and explained with additional specificity and detail through the accompanying drawings in which:

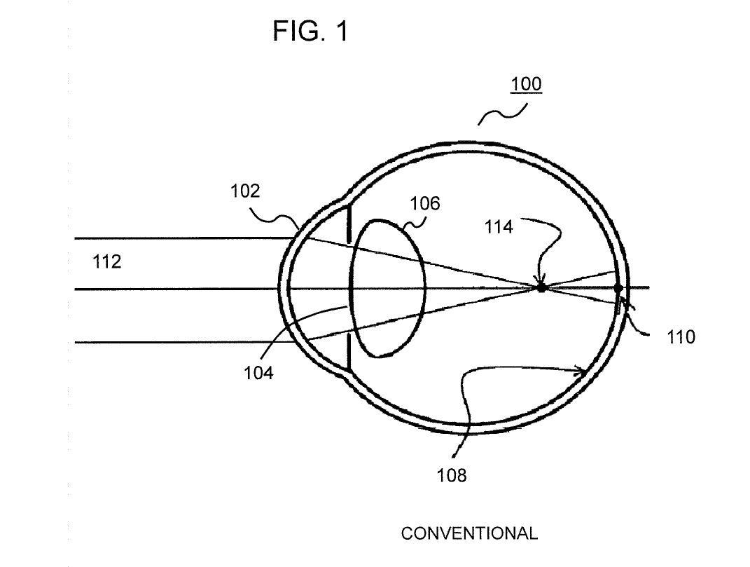

FIG. 1 illustrates a simplified schematic of a conventional myopic eye where rays from a distant object are focused in front of the retina.

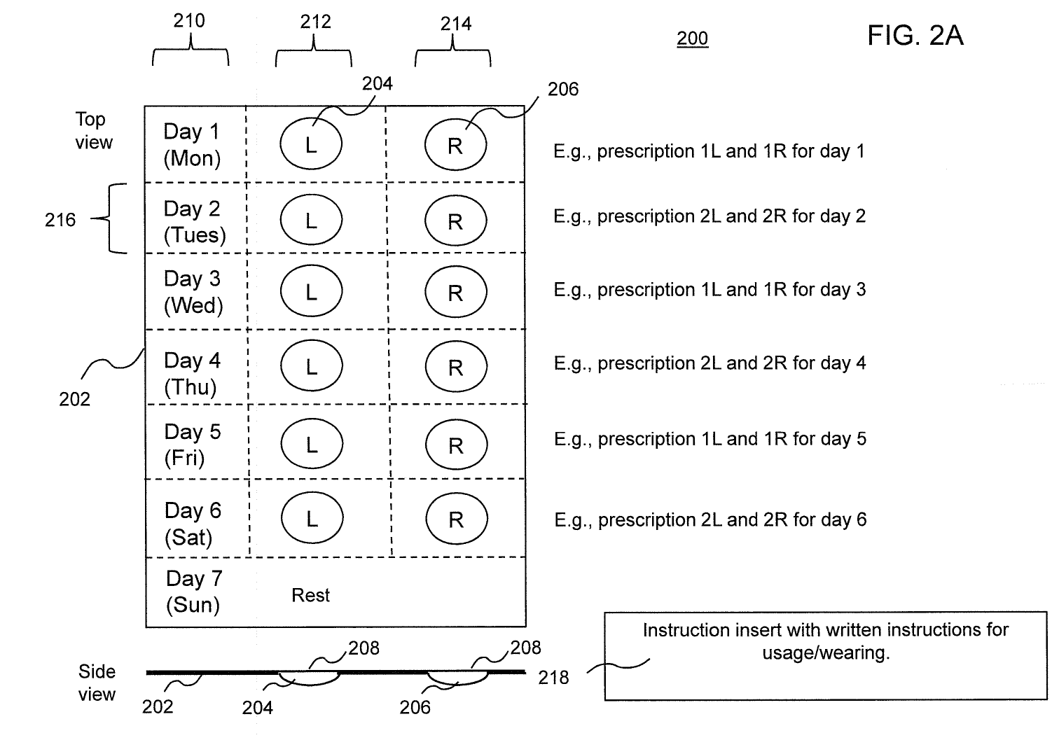

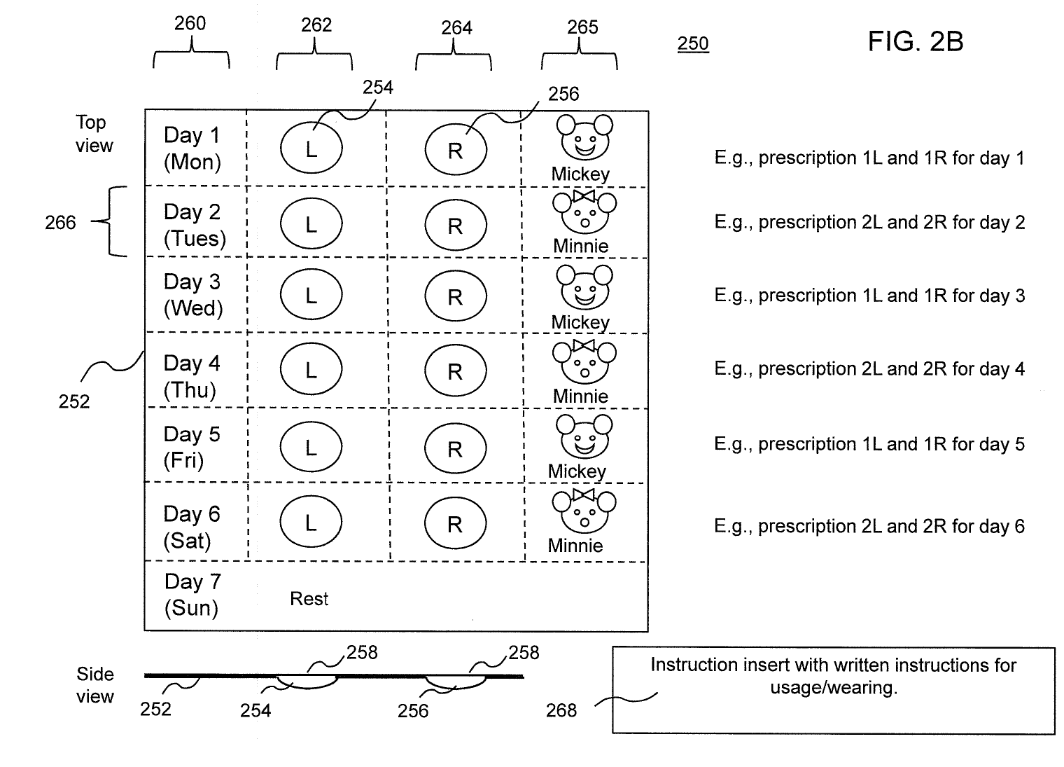

FIG. 2A illustrates an exemplary lens package or kit of contact lens pairs for affecting vision of the eyes, exercising the eyes, and/or inhibiting and/or controlling the progression of myopia for an individual according to an exemplary aspect of the disclosure.

FIG. 2B illustrates another exemplary lens package or kit of contact lens pairs for affecting vision of the eyes, exercising the eyes, and/or inhibiting and/or controlling the progression of myopia for an individual according to an exemplary aspect of the disclosure.

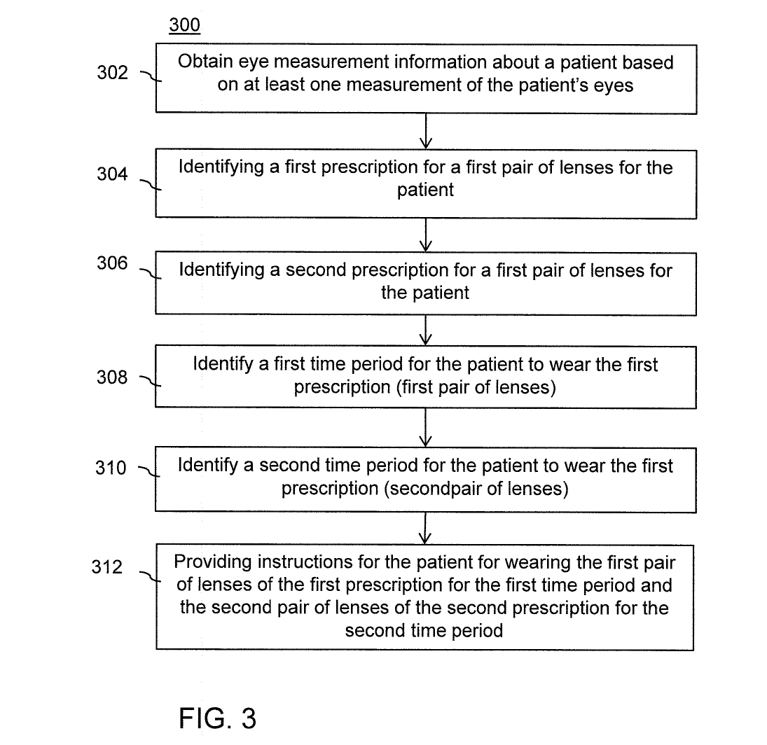

FIG. 3 illustrates a flow diagram for an exemplary method of prescribing lenses for affecting vision of the eyes, exercising the eyes, and/or inhibiting and/or controlling the progression of myopia for an individual according to an exemplary aspect of the disclosure.

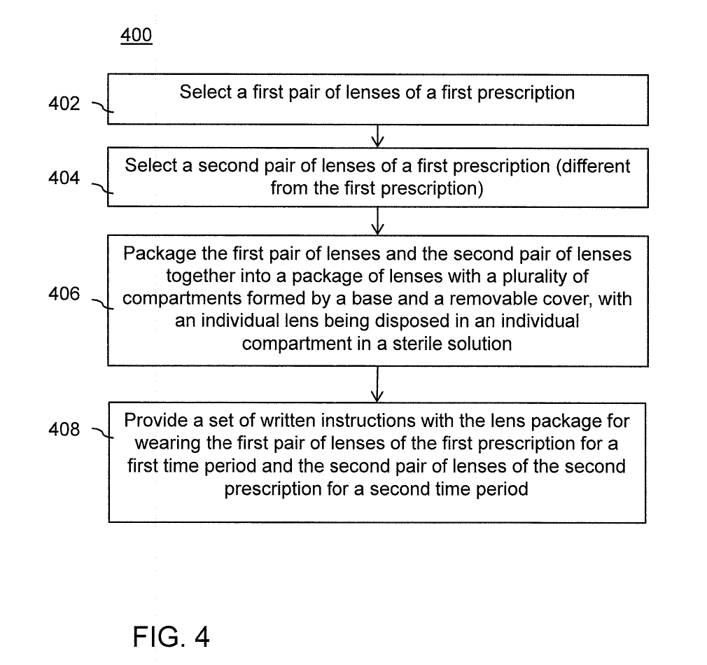

FIG. 4 illustrates a flow diagram for an exemplary method of manufacturing a lens package or kit for affecting vision of the eyes, exercising the eyes, and/or inhibiting and/or controlling the progression of myopia for an individual according to an aspect of the disclosure.

### DETAILED DESCRIPTION

The present disclosure is described in further detail with reference to one or more embodiments, some examples of which are illustrated in the accompanying drawings. The examples and embodiments are provided by way of explanation and are not to be taken as limiting to the scope of the disclosure. Furthermore, features illustrated or described as part of one embodiment may be used by themselves to provide other embodiments and features illustrated or described as part of one embodiment may be used with one or more other embodiments to provide further embodiments. The present disclosure covers these variations and embodiments as well as other variations and/or modifications.

The term “comprise” and its derivatives (e.g., comprises, comprising) as used in this specification is to be taken to be inclusive of features to which it refers, and is not meant to exclude the presence of additional features unless otherwise stated or implied.

It should also be understood that as used herein, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. The use of the terms “first,” “second,” “third,” etc. will be understood to denote labeling for differentiating some features from other features for purposes of convenience and not for specifying a particular ordering of features unless the context indicates otherwise. Finally, as used in the description herein and throughout the claims that follow, the meanings of “and” and “or” include both the conjunctive and disjunctive and may be used interchangeably unless the context expressly dictates otherwise.

The features disclosed in this specification (including accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

The subject headings used in the detailed description are included for the ease of reference of the reader and should not be used to limit the subject matter found throughout the disclosure or the claims. The subject headings should not be used in construing the scope of the claims or the claim limitations.

Exemplary aspects of the present disclosure are directed toward methods and lens systems, e.g., contact lenses or spectacles, for use in affecting the vision of the eye, exercising the eye, and/or inhibiting the progression of myopia. FIG. 1 illustrates a simplified schematic of a conventional myopic eye 100 where rays from a distant object are focused in front of the retina. The schematic illustration of the eye 100 in FIG. 1 is simplified in only showing several features of the eye 100. In addition, the sizes and distances associated with features are exaggerated for purposes of illustration. As shown in FIG. 1, the eye 100 includes a cornea 102, a pupil 104, a lens 106, a retina 108, and a fovea 110, which is a central portion of the retina 108 responsible for sharpest vision of the eye. In the example of FIG. 1, and rays 112 from a distant object enter the eye 100 through the cornea 102 and pupil 104 and are focused by the lens 106. Because the eye 100 is myopic, the rays 112 are focused at a point 114 in front of the fovea 110 instead of at the fovea 110 itself. Conventionally, corrective lenses, e.g., spectacles or contact lenses, may be used to refract the rays such that combined focusing of the lens 106 and the corrective lens attempts to focus the rays at the fovea 110. While this conventional approach may correct the immediate vision of the eye 100, it is ineffective to slow the progression of myopia over time.

It is believed that the use of certain types of lenses, such as multifocal contact lenses, may reduce the rate of progression of myopia for myopic individuals, particularly children. However, a difficulty with this proposition is the degradation of distance vision with some multifocal prescriptions, which may cause compliance issues in subjects, i.e., non-use for a necessary duration of scheduled wear, particularly for children. For example, children may not have suitable vision in certain outdoor activities while wearing such lenses and as a result may not wear such lenses as suggested.

Approaches described in the present disclosure may provide minimal reduction in distance vision while maintaining the efficacy of the potential reduction in the rate of myopia progression. In this regard, the approaches described herein involve identifying, selecting, or wearing two or more pairs of lenses for refractive correction for myopic subjects, wherein one pair of lenses has a prescription different than the prescription of another pair of lenses. A “prescription” for (or of) a pair of lenses as referred to herein refers to corrective optical properties of the lenses that include at least the corrective powers of the pair of lenses. Lenses that are “corrective” in this regard need not provide full or complete correction of an optical condition. Lenses that provide a partial correction of an optical condition are considered “corrective” lenses, and corrective lenses may or may not provide a focus at the fovea. A “prescription” as referred to herein is not limited to corrective optical information identified or selected by an ophthalmologist, optometrist or other medical doctor, but may include corrective optical information determined in a suitable manner, including that determined with the use of optical equipment, including automated optical equipment, operated by a technician who is not an ophthalmologist, optometrist or other medical doctor.

In some examples, a pair of lenses of a given prescription is to be worn for a prescribed time period, e.g., for a day (e.g., the waking hours of the day), more than a day, some portion of day (such as 12 hours), 24 hours, 36 hours, 48 hours, 72 hours, one week, two weeks, etc., or combinations thereof. For instance, a first pair of lenses of a first prescription (comprising a first lens for the left eye and a first lens for the right eye) may be worn for a first time period, such as during the awake hours of a first day (e.g., Monday), and a second pair of lenses of second prescription (comprising a second lens for the left eye and the second lens for the right eye) may be worn for a second time period, such as during the awake hours of a second day (e.g., Tuesday). For convenience, the first prescription (for the first pair of lenses) may be referred to with designations 1L and 1R, where “1L” refers to the first prescription for the left eye, and “1R” refers to the first prescription for the right eye. Similarly, the second prescription (for the second pair of lenses) may be referred to with designations 2L and 2R, where “2L” refers to the second prescription for the left eye, and “2R” refers to the second prescription for the right eye. However, other suitable designations may be used. After the second time period (e.g., a second day), the myopic subject may revert to wearing lenses of the first prescription for a third time period (e.g., a third day—Wednesday) and wearing lenses of the second prescription for a fourth time period (e.g., a fourth day—Thursday). Similarly, the first lenses may be worn for a fifth time period (e.g., a fifth day—Friday), and the second lenses may be worn for a sixth time period (e.g., a sixth day—Saturday). A seventh time period, e.g., a seventh day (Sunday) may be reserved for wearing ordinary corrective spectacles, e.g., to provide normal corrected outdoor vision so that they eyes may be rested instead of wearing either the first or second pairs of lenses. The schedule for wearing the first and second pairs of lenses may then be repeated, e.g., first lenses on one day and second lenses on the next day in an alternating fashion. It should be understood that the first time period may be the same, substantially the same or similar in duration as the second time period, or the first time period may be different than the second time period. It will be understood that the first time period and the second time period need not be particularly defined times of a specific number of hours. For example, the first time period and the second time period could be specified more generally, e.g., such as the waking hours of a day, or a fraction of a day in which the eyes are able tolerate the lenses without becoming overly fatigued, which may vary from individual to individual. Such times are still considered to be within the scope of a first time period, a second time period, a third time period, etc.

Alternatively, a third prescription (or one or more additional prescriptions) may be utilized in conjunction with first and second prescriptions. For example, a pair of lenses of the third prescription may be worn on the third day, lenses of the first prescription may be worn on the fourth day, lenses of the second prescription may be worn on the fifth day, and lenses of the third prescription may be worn on the sixth day. Ordinary corrective spectacles may be worn on the seventh day provide normal corrected outdoor vision so that they eyes may be rested instead of wearing either the first, second or third pairs of lenses on the seventh day (e.g., Sunday). This exemplary schedule may then be repeated. While the time period of one day, or the waking hours of one day, is mentioned in the examples above, other time periods are possible. For example, the myopic subject could wear lenses of a first prescription for two days and then wear lenses of a second prescription for two days, and so on in an alternating fashion. A different number of days or hours other than one or two days could also be used. In this regard, suitable time periods may be determined based on one or more factors, for example, evaluations of the person to ascertain advantageous time periods for lens wear depending upon age of the subject and current state of myopia, depending upon the typical activities and the duration of such activities in which the person participates, or depending upon the rate of myopia progression, or combinations thereof.

In some embodiments, the first lens for the left eye and the second lens for the right eye may be configured to provide corrected normal central vision, and the first lens for the right eye and the second lens for the left eye may be configured to not provide normal central vision correction. In this regard, the lenses that are configured to not provide corrected normal central vision may exercise the eye and/or cause the eye to change shape overtime in a manner that may inhibit the progression of myopia. Lens types that may be used in the approaches described herein include single vision, bifocal and multifocal optics, “center-distance,” “center-near” and “concentric ring” type bifocals and multifocals. Other types of lenses may also be used as described elsewhere herein.

Another example involves using two sets of first and second lens pair prescriptions (i.e., four pairs of lens prescriptions), e.g., one set of two lens pairs for an initial treatment period (e.g., 2, 3, 4, 5, 6, 8, 10, 12 weeks, or other number of weeks) and another set of two lens pairs for a subsequent treatment period (e.g., 2, 3, 4, 5, 6, 8, 10, 12 weeks, or other number of weeks). In this example, the individual may initially alternate between wearing a first pair of lenses and wearing a second pair of lenses of the first set such that in both pairs of lenses a left lens may be used in proximity to a left eye to achieve emmetropia in the left eye while the right lens used in proximity of the right eye may affect the right eye to change shape over time in a manner that may inhibit myopia progression of the right eye. Once the initial set of two pairs of lenses has been used, e.g., alternated over a prescribed period of time, a subsequent set of two pairs of lenses may be used, wherein a right lens for both pairs of lenses may be used in proximity to right eye to achieve emmetropia in the right eye while the left lens of both pairs used in proximity of the left eye may affect the left eye to change shape over time in a manner that may inhibit myopia progression of the left eye. The order of treatment of the left eye or the right eye could be reversed, of course. Thus, for example, the two sets of lens pairs as described above could be prescribed such that during an initial treatment period the left eye has corrected normal vision while the right eye is exercised with lenses that provide a refraction correction other than corrected normal vision, and such that during a subsequent treatment period the right eye has corrected normal vision while the left eye is exercised with lenses that provide a refraction correction other than corrected normal vision. It will be appreciated that this approach can permit an individual, particularly a child, to have adequate vision in at least one eye during a given daytime period so that the individual can participate in typical activities that require adequate vision.

As noted, various lens types may be used in the approaches described herein, including single vision, bifocal and multifocal optics, as well as other types of lenses. In an example involving two pairs of lenses, the first lens for the left eye and the second lens for the right eye may be configured to provide normal central vision correction (normal on-axis correction). Also, the first lens for the right eye and the second lens for the left eye may be configured to provide peripheral image points that are not focused on the retinas of the right and the left eyes in peripheral region outside the foveas of the right and left eyes, such that image points are disposed predetermined distances away from the retina, and suitable lenses of this type may be configured as disclosed, for example, in U.S. Pat. No. 7,025,460, the entire contents of which are incorporated herein by reference. In this regard, lenses of the type described in U.S. Pat. No. 7,025,460, may provide for corrected on-axis vision and may also provide image points in the peripheral (off-axis) region outside the fovea that deviate from the curved image surface of the retina. As an example, a soft contact lens comprising a combination of conic sections and polynomial equations for its optical zone surfaces may be used. The back surface may comprise a conic section type surface with a suitable apical radius (r₀) and shape factor (p). The basic front surface may comprise a conic section with suitable apical radius (r₀) and shape factor (p) with additional sagittal height added to this basic surface described by a polynomial equation In some examples, both the tangential and sagittal focal positions may be placed anterior to the retina with such lenses. In some examples, lenses with zero refractive power may be used, wherein the back surface of the lens comprises a conic section with suitable apical radius (r₀) and shape factor (p), wherein the front surface of the lens comprises a basic aspherical surface with additional sagittal height added to this basic surface given by a polynomical equation, which lens can place both the tangential and sagittal focal positions anterior to the retina. Various contact lens materials could be used, such as a silicone hydrogel material, for example. While such lenses may be described in terms of conic sections and polynomial equations such as noted above, other surface descriptors may be used including splines, Beziers, Fourier series synthesis, Zernike polynomial as sagittal height descriptors, or combinations of any of the foregoing, or a more general point-by-point surface description via a look-up-table or similar approaches. Further, the design of optical devices of the present invention is not limited to the design of optical surface profiles. For example, gradient refractive index (GRIN) materials may be used to manipulate the relative curvature of field, as may Fresnel-type optics, holographic or diffractive optics be used, either individually or in combinations with each other or with the surface profile design approaches, whereby image points in the peripheral (off-axis) region outside the fovea can be manipulated to deviate from the curved image surface of the retina. Such lenses have shown promise for inhibiting the progression of myopia in subjects, and it is believed that additional benefit in inhibiting the progression of myopia can be obtained by combining use of such lenses with the approaches described herein involving alternating the wearing of two or more pairs of lenses of different prescriptions for specified time periods. In examples, the first lens for the left eye and second lens for the right eye may provide a deviation from normal corrected central (on-axis) vision to provide for addition exercising of the eyes.

Other suitable lenses for providing a refractive correction, e.g., partial or full correction, for use in connection with the approaches described herein may include lenses having non-monotonic radial power profiles. For example, one or more power profiles that may be characterized by non-monotonic functions over a substantial portion of the half-chord optical zone of the lens. For example, lenses that are configured such that the at least one power profile is non-monotonic over a substantial portion of the half-chord optical zone of the lens. In general terms, a monotonic or monotone, function is a function which either is substantially non-increasing or substantially non-decreasing. A function F(x) is said to be non-increasing on an interval I of real numbers if: F(b)<=F(a) for all b>a; where a, b are real numbers and are a subset of I; A function F(x) is said to be non-decreasing on an interval I of real numbers if: F(b)>=F(a) for all b>a; where a, b are real numbers and are a subset of I. Other exemplary embodiments may have one or more power profiles that may be characterized by non-monotonic and aperiodic functions over a substantial portion of the half-chord optical zone of the lens. Certain embodiments are directed to lenses that are configured such that the at least one power profile is non-monotonic and aperiodic over a substantial portion of the half-chord optical zone of the lens. Certain exemplary embodiments have one or more power profiles that may be characterized by aperiodic functions over a substantial portion of the half-chord optical zone of the lens. Certain exemplary embodiments are directed to lenses that are configured such that the at least one power profile is aperiodic over a substantial portion of the half-chord optical zone of the lens. In general terms, an aperiodic function is defined as a function that is not periodic. A periodic function is a function that repeats or duplicates its values in regular intervals, often denoted as periods. For example, trigonometric functions (i.e. sine, cosine, secant, cosecant, tangent and cotangent functions) are periodic as their values are repeated over intervals of a radians. A periodic function may also be defined as a function whose graphical representation exhibits translational symmetry. A function F(x) is said to be periodic with a period P (where P is a non-zero constant), if it satisfies the following condition: F(x+P)=F(x). Examples of these types of lenses are described in International Patent Publication Nos. WO2013/149303 and WO2014/059465, the entire contents of which are incorporated herein by reference.

In addition, other suitable lenses for providing a refractive correction, e.g., partial or full correction, may include lenses having higher-order symmetric and/or asymmetric aberration profiles. Yet other suitable lenses for providing a refractive correction may include lenses having high-order symmetric and/or asymmetric power profiles. The most commonly measured higher order ocular aberrations (HOA) include spherical aberration, coma and trefoil. Apart from these, the HOA profiles obtained with some multifocal optical designs precipitate considerable magnitudes of wavefront aberrations, often expressed up to the 10th order in Zernike polynomial representation. In general terms, in the Zernike pyramid, the terms closer to the centre are often more influential, or useful, when gauged in terms of the resultant optical effects than those at the edge/comer. This may be because the terms farther away from the centre have a relatively large planar area on the wavefront compared to those whose angular frequency is closer to zero. In certain embodiments, Zernike terms that have the highest potential, or substantially greater potential, to interact with defocus are, for example, the terms with even radial order having zero angular frequency component, i.e., the fourth, sixth, eighth and tenth order Zernike coefficients, representing primary, secondary, tertiary and quaternary spherical aberrations. Other Zernike coefficients representing other order of spherical aberration may also be used. As defined herein, the term aberration profile may be an arrangement of one or more aberrations in a one dimensional, a two dimensional or a three dimensional distribution. The arrangement may be continuous or discontinuous. Aberration profiles may be brought about by an arrangement of one or more power profiles, power patterns and power distributions in a one dimensional, a two dimensional or a three dimensional distribution. The arrangement may be continuous or discontinuous. Aberrations may be rotationally symmetric or asymmetric. Examples of these types of lenses are described in International Patent Publication Nos. WO2013/149303 and WO2014/059465, the entire contents of which are incorporated herein by reference.

Optical designs that affect the slope of through-focus retinal image quality, both on-axis and/or off-axis, may include lenses that include non-monotonic power profiles, lenses having higher-order symmetric and/or asymmetric aberration profiles, a combination thereof, or other suitable lenses. With use of a wavefront aberrometer, such as a Hartmann-Shack instrument, the optical characteristics of a candidate eye with or without refractive correction, model eye with or without refractive correction may be measured so as to identify a measure of retinal image quality (RIQ). In some examples, the model eye used may be a physical model that is anatomically, optically equivalent to an average human eye. In certain examples, the RIQ may be calculated via optical calculation methods like ray-tracing and/or Fourier optics. Several measures of RIQ are known and may be used.

The RIQ may be considered anterior and/or posterior to, the retina. The RIQ anterior and/or posterior to the retina is called ‘through focus RIQ herein and abbreviated as TFRIQ herein. Similarly, RIQ at and/or around the retina may also be considered over a range of focal lengths (i.e., when the eye accommodates, which causes changes in refractive characteristics of the eye in addition to the focal length to change).

Certain embodiments may consider not only RIQ at the retina, but also the change in through focus RIQ. For example, certain embodiments disclosed herein effect, or are designed to effect, for a myopic eye with particular refractive characteristics, a change in or control over the extent or rate of change in RIQ degradation in the direction of eye growth and/or posterior to the retina. Certain embodiments may also effect, or are designed to effect, a change in or control over the variation in RIQ with focal distance. For example, several candidate lens designs may be identified through effecting a change in the RIQ degrading in the direction posterior to the retina and then a single design or subset of designs may be identified taking account of variation in RIQ with change in focal length. In particular, a set of designs is selected based on changes in RIQ at the retina with focal distance. Selection within the set is then made with reference to the TFRIQ. In certain embodiments, a single evaluation process is conducted that combines consideration of TFRIQ and changes of RIQ at the retina with the focal distance. For example, an average measure of RIQ with changes in focal distance may be used to identify a design. The average measure may give more weight to particular focal distances (e.g. distance vision, intermediate vision and near vision and therefore may be weighted differently). For example, an average measure of RIQ with changes in focal distance may be used to identify a design that may be used with certain devices, lenses and/or methods disclosed herein, for example, a measure of RIQ averaged over a range of focal distances. The average measure may be a weighted average measure that may give more weight or emphasis to particular focal distances (e.g., distance vision, intermediate vision and near vision and therefore may be weighted differently). The RIQ may also be considered across a selected area on the retina. The RIQ over a selected portion of the retina is called global RIQ. The global RIQ may also be considered in the direction of eye growth and/or posterior to the retina. The global RIQ considered anterio-posterior to the retina is referred to as through-focus global RIQ or TFGRIQ. Similarly, global RIQ at and/or about the retina may also be considered over a range of focal lengths. For example, when the eye accommodates, which causes changes in refractive characteristics of the eye, its focal length also changes. Certain embodiments may consider not only RIQ at the retina, but also the change in through focus RIQ. This is in contrast to an approach that may, for example, consider only the RIQ at the retina and/or an integral or summation of RIQ measures at or around the retina. Certain embodiments may consider not only global RIQ at the retina, but also the change in through focus global RIQ. For example, certain embodiments disclosed herein effect, or are designed to effect, for a myopic eye with particular refractive characteristics, a change in or control over the extent or rate of change in RIQ that degrades in the direction of eye growth and/or posterior to the retina. Certain embodiments may also effect, or are designed to effect, a change in or control over the variation in RIQ with focal distance. For example, several candidate lens designs may be identified through effecting a change in the RIQ degradation in the direction of eye growth and/or posterior to the retina and then a single design or subset of designs may be identified taking account of variation in RIQ with change in focal distance. In particular, a set of designs is selected based on changes in RIQ at the retina with focal distance. Selection within the set is then made with reference to the TFRIQ. In some embodiments, a single evaluation process is conducted that combines consideration of TFRIQ and changes of RIQ at the retina with the focal distance. For example, an average measure of RIQ with changes in focal distance may be used to identify a design that may be used with certain embodiments herein. The average measure may give more weight to particular focal distances (e.g., distance vision, intermediate vision and near vision and therefore may be weighted differently). In certain embodiments, through focus and/or changes of RIQ at the retina with focal distance are considered for one or more of the following: i) on-axis, ii) integrated around on axis, for example in an area corresponding to or approximating a pupil size, with or without consideration of the Stiles-Crawford effect, iii) off-axis (where off-axis means a location, set of locations and/or integral of locations on the retina outside the fovea, which may be where light at field angles more than about 10 degrees is focused), and iv) one or more combinations of i) to iii). In certain applications, the field angles are about 15 or more, 20 or more, 25 or more or 30 or more degrees. While the description herein refers to quantitative measures of RIQ, qualitative measures may also be used to assist the design process of an aberration profile in addition to the quantitative measures. For example, the visual Strehl Ratio at a particular through focus location is computed or determined based on the point spread function. This provides for a method of qualitatively evaluating through focus. In some embodiments, an image quality produced by a lens and/or device at its focal distance is computed without the use of a model eye. The image quality produced by a lens and/or device may be calculated anterior and/or posterior to the focal distance of the lens and/or device. The image quality anterior and/or posterior to the focal distance may be referred to as through focus image quality. The through-focus range has a negative and a positive power end relative to the focal distance. Some other lenses may include those that alter the instantaneous gradient of the through-focus retinal image quality compared to the uncorrected eye. These embodiments may utilize the gradient or slope of the RIQ to control myopia progression, with or without astigmatism. The gradient or slope of RIQ may be considered for one or more of the following variants of RIQ: a) monochromatic RIQ with or without considering effect of accommodation, b) polychromatic RIQ with or without considering effect of accommodation, c) global RIQ, d) RIQ considered with myopic impetus time signal, and e) global RIQ with myopic impetus time signal. Examples of these types of lenses are described in International Patent Publication Nos. WO2013/149303 and WO2014/059465, the entire contents of which are incorporated herein by reference.

For two or more pairs of lenses considered to correct and treat a pair of eyes of an individual who has been diagnosed with myopia or progressive myopia, one lens of a given lens pair may be considered as the correcting lens used in proximity of the corrected eye, and the other lens may be considered as the treatment lens used in proximity of the treated eye. In another example, a pair of lenses may have one lens used to both correct and treat one eye while the other lens may be used to treat but not correct the other eye. In yet another example, a pair of lenses may be configured so that both lenses of the pair both correct and treat the eyes.

For a pair of lenses, the choice of prescription for a lens designated to provide corrected normal central (i.e., on axis) vision may be based, for example, upon industry norms for achieving a desired vision correction for the eye in consideration. The choice of prescription for a lens designated to exercise the eye by providing a refractive correction other than normal central (i.e., on axis) vision may be based on, for example, but not limited to, the age of the potential candidate, magnitude of myopia of the potential candidate eye, rate of progression of the potential candidate eye, amplitude of accommodation of the potential candidate eye, amount of near work done by the potential candidate and so on. The choice of the prescription may further depend upon the amount of refractive or residual astigmatism and size of the pupil at various illumination levels.

Table 1 illustrates descriptions of several non-limiting examples of prescription types for contact lens pairs that may be used in approaches to affect the vision of the eyes of a person, exercise the eyes and/or inhibit the progression of myopia of the eyes. The examples of Table 1 involve prescriptions for two pairs of lenses, i.e., four lenses in total. The listed pairs of prescription lenses may be prescribed for wear as noted above, the first prescription pair for a first time period (e.g., a day, couple of days, week, couple of weeks, month, etc), and the second prescription pair for a second time period (e.g., a day, couple of days, week, couple of weeks, month, etc). The actual prescriptions 1L, 1R, 2L and 2R listed for Examples 1-12 may be determined based on techniques employed, for example, by an optometrist to determine appropriate powers of corrective lenses for providing satisfactory levels of corrected vision. For example, once a determination has been made for what would be considered normal corrections for a given individual's eyes, the appropriate deviations from normal corrected vision can be determined according to approaches described herein.

In Table 1 below, certain exemplary applications of multifocal lenses are designated with the following types: TYPE I—a multifocal lens that is designed to achieve expansion in the perceivable depth-of-focus via selective manipulation of higher order aberrations; TYPE II—a multifocal lens that is designed to achieve expansion in the perceivable depth-of-focus via selective manipulation of higher order aberrations and also minimize the number of phase reversals in a through focus the phase trans function; TYPE III—a multifocal lens that is designed to achieve expansion in the perceivable depth-of-focus via selective manipulation of higher order aberrations, designed to provide optical/visual performance substantially independent of a patient's pupil size and/or substantially independent of a patient's inherent ocular aberrations; TYPE IV—multifocal with a gradient of the on-axis (or global) through-focus retinal image quality that is decreasing in the direction of eye growth and/or have an on-axis retinal image quality of 0.2 or greater. Such lenses are described in International Publication Nos. WO2013/149303 and WO2014/059465. Where one of the aforementioned TYPEs is not listed, the multifocal lens should be understood to be that of typical multifocal lens.

TABLE 1
Exemplary combinations of lens pairs

| | PAIR 1 | | PAIR 2 | | |
|---|---|---|---|---|---|
| | Left Eye | Right Eye | Left Eye | Right Eye | |
| | (prescription | (prescription | (prescription | (prescription | EXEMPLARY |
| No. | 1L) | 1R) | 2L) | 2R) | APPLICABILITY |
| 1 | Single vision | Single vision | Single vision | Single vision | An individual, who is at |
| | lens for | lens for near | lens for near | lens for | least 6 years old, and |
| | distance | vision | vision | distance | having at least −0.75D of |
| | vision | | | vision | myopia where the |
| | | | | | myopia is progressing at |
| | | | | | least 0.50 a year. This |
| | | | | | individual also spends a |
| | | | | | predominant amount of |
| | | | | | their awake hours |
| | | | | | working/studying and |
| | | | | | have working distances |
| | | | | | below 50 cm. |
| 2 | Single vision | Single vision | Single vision | Single vision | An individual, who is at |
| | lens for | lens for | lens for | lens for | least 6 years old, and |
| | distance | intermediate | intermediate | distance | having at least −0.75D of |
| | vision | vision | vision | vision | myopia where the |
| | | | | | myopia is progressing at |
| | | | | | least 0.50 a year. This |
| | | | | | individual spends a |
| | | | | | predominant amount of |
| | | | | | their awake hours |
| | | | | | working/studying and |
| | | | | | have working distances |
| | | | | | in the intermediate |
| | | | | | range, for example, |
| | | | | | between 40 to 80 cm. |
| 3 | Single vision | Ordinary | Ordinary | Single vision | An individual(s), who is |
| | lens for | bifocal or | bifocal or | lens for | at least 6 years old, and |
| | distance | multifocal | multifocal | distance | having at least −0.75D of |
| | vision | with an | with an | vision | myopia where the |
| | | effective add | effective add | | myopia is progressing at |
| | | power of, | power of, | | least 0.50 a year. This |
| | | e.g., | e.g., | | individual may equally |
| | | +3.00/+2.50/ | +3.00/+2.50/ | | engage in studying and |
| | | +2.00/+1.50/ | +2.00/+1.50/ | | outdoor sport. |
| | | +1.00D. | +1.00D. | | The effective add power |
| | | | | | for an individual may be |
| | | | | | determined based on |
| | | | | | their predominant |
| | | | | | working distance. For |
| | | | | | example +1.50D add for |
| | | | | | an individual with a |
| | | | | | working distance of |
| | | | | | 70 cm and +2.50D for |
| | | | | | another who's working |
| | | | | | distance of 40 cm. |
| 4 | Single vision | Multifocal | Multifocal | Single vision | An individual(s), who is |
| | lens for | (TYPES I, II, | (TYPES I, II, | lens for | at least 6 years old, and |
| | distance | III, IV) with | III, IV) with | distance | having at least −0.75D of |
| | vision | effective add | effective add | vision | myopia where the |
| | | power of, | power of, | | myopia is progressing at |
| | | e.g., | e.g., | | least 0.50 a year. This |
| | | +3.00/+2.50/ | +3.00/+2.50/ | | individual(s) may |
| | | +2.00/+1.50/ | +2.00/+1.50/ | | equally engage in |
| | | +1.00D. | +1.00D. | | studying and outdoor |
| | | | | | sport. The effective add |
| | | | | | power for an individual |
| | | | | | may be determined |
| | | | | | based on their |
| | | | | | predominant working |
| | | | | | distance. For example |
| | | | | | +1.50D add for an |
| | | | | | individual with a |
| | | | | | working distance of |
| | | | | | 70 cm and +2.50D for |
| | | | | | another who's working |
| | | | | | distance of 40 cm. These |
| | | | | | individuals may |
| | | | | | additionally have a |
| | | | | | gradient of RIQ that is |
| | | | | | increasing in the |
| | | | | | direction of eye growth. |
| | Single vision | Ordinary | Ordinary | Single vision | An individual, who is at |
| | lens for | bifocal/multifocal | bifocal/ | lens for | least 6 years old, and |
| | intermediate | with | multifocal | intermediate | having at least −0.75D of |
| | vision | effective add | with | vision | myopia where the |
| | | power of, | effective add | | myopia is progressing at |
| | | e.g., | power of, | | least 0.50 a year. This |
| | | +3.00/+2.50/ | e.g., | | individual may equally |
| | | +2.00/+1.50/ | +3.00/+2.50/ | | engage in studying and |
| | | +1.00D. | +2.00/+1.50/ | | indoor sport, for |
| | | | +1.00D. | | example: video games. |
| | | | | | The effective add power |
| | | | | | for an individual may be |
| | | | | | determined based on |
| | | | | | their predominant |
| | | | | | working distance, for |
| | | | | | example +1.50D add for |
| | | | | | an individual whose |
| | | | | | computer screen/video |
| | | | | | game monitor is located |
| | | | | | at a distance of 70 cm. |
| 6 | Single vision | Ordinary | Ordinary | Single vision | An individual, who is at |
| | lens for near | bifocal/multifocal | bifocal/ | lens for near | least 6 years old, and |
| | vision | with | multifocal | vision | having at least −0.75D of |
| | | effective add | with | | myopia where the |
| | | power of, | effective add | | myopia is progressing at |
| | | e.g., | power of, | | least 0.50 a year. This |
| | | +3.00/+2.50/ | e.g., | | individual may be fully |
| | | +2.00/+1.50/ | +3.00/+2.50/ | | engage in studying and |
| | | +1.00D. | +2.00/+1.50/ | | rarely involved in |
| | | | +1.00D. | | outdoor or indoor sport. |
| | | | | | The effective add power |
| | | | | | may be determined |
| | | | | | based on their |
| | | | | | predominant working |
| | | | | | distance, for example |
| | | | | | +2.50D for an individual |
| | | | | | reads at 40 cm |
| 8 | Single vision | Multifocal | Multifocal | Single vision | An individual, who is at |
| | lens for near | (TYPES I, II, | (TYPES I, II, | lens for near | least 6 years old, and |
| | vision | III, IV) with | III, IV) with | vision | having at least −0.75D of |
| | | effective add | effective add | | myopia where the |
| | | power of, | power of, | | myopia is progressing at |
| | | e.g., | e.g., | | least 0.50 a year. This |
| | | +3.00/+2.50/ | +3.00/+2.50/ | | individual may be fully |
| | | +2.00/+1.50/ | +2.00/+1.50/ | | engage in studying and |
| | | +1.00D. | +1.00D. | | rarely involved in |
| | | | | | outdoor or indoor sport. |
| | | | | | The effective add power |
| | | | | | may be determined |
| | | | | | based on their |
| | | | | | predominant working |
| | | | | | distance, for example |
| | | | | | +2.50D for an individual |
| | | | | | reads at 40 cm. |
| | | | | | This individual may |
| | | | | | additionally have a |
| | | | | | gradient of RIQ that is |
| | | | | | increasing in the |
| | | | | | direction of eye growth. |
| 8 | Multifocal | Multifocal | Multifocal | Multifocal | An individual, who is at |
| | with | (TYPES I, II, | (TYPES I, II, | with | least 6 years old, and |
| | effective add | III, IV) with | III, IV) with | effective add | having at least −0.75D of |
| | power of, | effective add | effective add | power of, | myopia where the |
| | e.g., +1.00D | power of, | power of, | e.g., +1.00D | myopia is progressing at |
| | add power or | e.g., +2.00D | e.g., +2.00D | add power or | least 0.50 a year. This |
| | lower | or greater | or greater | lower | individual may equally |
| | | | | | engage in studying and |
| | | | | | indoor sport, for |
| | | | | | example: video games. |
| | | | | | The effective add power |
| | | | | | for the individual may |
| | | | | | be determined based on |
| | | | | | their predominant |
| | | | | | working distance, for |
| | | | | | example +1.50D add for |
| | | | | | an individual whose |
| | | | | | computer screen/video |
| | | | | | game monitor is located |
| | | | | | at a distance of 70 cm. |
| | | | | | This individual may |
| | | | | | additionally have a |
| | | | | | gradient of RIQ that is |
| | | | | | increasing in the |
| | | | | | direction of eye growth. |
| 9 | Multifocal | Multifocal | Multifocal | Multifocal | An individual, who is at |
| | with | with | with | with | least 6 years old, and |
| | effective add | effective add | effective add | effective add | having at least −0.75D of |
| | power of | power of | power of | power of | myopia where the |
| | +1.00D add | +2.00D or | +2.00D or | +1.00D add | myopia is progressing at |
| | power or | greater | greater | power or | least 0.50 a year. This |
| | lower | | | lower | individual may equally |
| | | | | | engage in studying and |
| | | | | | indoor sport. |

The examples listed in Table 1 merely reflect several of many possible combinations of prescriptions for lens pairs to be worn for specified time periods according to the present disclosure. They are exemplary and are not intended to be limiting. Though the rightmost column lists exemplary applicability, the example pairs of the lenses are not limited to the types of individuals listed there and could be utilized for other types of individuals as well. The specific numerical designations for bifocal lenses and multifocal lenses in Table 1 are entirely exemplary and not intended to be limiting. In certain embodiments, the myopic person does not wear the same set of prescription lenses every day for an extended time period, e.g., one month, six months, one year, etc. Rather, the myopic person alternates between wearing lens pairs of two or more different prescriptions during prescribed time periods.

In light of the examples above, it will be appreciated that at least one of the first pair of lenses and the second pair lenses may be selected to reduce the rate of myopia progression of an individual. Also, at least one of the first pair of lenses and the second pair lenses may be selected to reduce the degradation of distance vision. In addition, at least one of the first pair of lenses and the second pair lenses may be selected to reduce the rate of myopia progression and to reduce the degradation of distance vision.

In certain embodiments, the alternating between wearing the first pair of lenses and the second pair of lenses, permits one eye (e.g., the left eye) to experience normal corrected central vision during a first time period (e.g., one day) and to experience a deviation from normal corrected central vision during a second time period (e.g., the next day). During the same time, the alternating wear schedule permits the other eye (e.g., the right eye) to experience to experience a deviation from normal corrected central vision during the first time period and to experience normal corrected central vision during the second time period. Thus, while one eye is being exercised to experience a deviation from normal corrected central vision, the other eye experiences normal corrected vision. This permits the individual, e.g., a child, to see clearly and participate in typical activities ordinarily encountered on each day. Thus, the individual is more likely to comply with the suggested schedule of lens wearing, and may reap the benefits of both clear vision and progress in exercise of the eyes and/or slowing of the progression of myopia.

In accordance with another exemplary aspect of the disclosure, an exemplary lens package of lens pairs (e.g., a kit of lens pairs) 200 configured according to two or more prescriptions to be worn for specified time periods is shown in FIG. 2A. The lens package 200 may include a plastic base 202 with multiple rounded depressions 204 and 206, where an individual compartment holds an individual lens, and removable cover portions 208 (e.g., a continuous aluminum foil with perforations that separate individual compartments, or separate aluminum foil portions for each compartment) attached to the plastic base 202 with a suitable adhesive. The package may be configured such that when the foil cover is adhered to the base 202, a depression 204, 206 forms a separate liquid-tight compartment for holding a single contact lens in sterile saline solution. As shown in FIG. 2A, the lens package 200 may include various different regions. The package 200 may include a region 210 for designating a day number, day of the week, or numerical sequence for assisting the wear with opening the proper compartments for a given period's usage. In the example of FIG. 2A, the period of usage of a given lens pair is 1 day, but other periods of usage for a given lens pair may be used, e.g., 1 day, 2 days, etc. Different portions of package may be separable by virtue of perforations formed in the base 202 shown by dotted lines in FIG. 2A, such that those portions may be separated from each other by tearing along the perforations, if desired.

The package 200 may also include a region 212 of left-eye lenses arranged along a column and a region 214 of right-eye lenses arranged along a column. Thus, each given row 216 of lenses may include a numerical designation for the time period (e.g., day number or day of the week) as well as a right lens and a left lens. Each row of lenses may be populated with the appropriate pair of prescription lenses for that time period. For example, the first row designated with the number “1” includes a left-eye lens of prescription 1L and a right-eye lens of prescription 1R. The second row designated with the number “2” includes a left-eye lens of prescription 2L and a right-eye lens of prescription 2R. In this example, those two prescriptions (1L/1R and 2L/2R) of lens pairs may then repeated to provide multiple first pair lenses and multiple second pair lenses. However, it will be appreciated that other configurations involving more than two pairs of lenses and/or involving different time periods for wear are possible. The lens package or kit 200 may also include an instruction insert 218, e.g., printed on paper, comprising written instructions for usage and wearing (e.g., guidelines for re-use and disposal, wearing times, etc.)

In accordance with another exemplary aspect of the disclosure, an exemplary lens package of lens pairs (e.g., a kit of lens pairs) 250 configured according to two or more prescriptions to be worn for specified time periods is shown in FIG. 2B. This example includes an addition of artwork to the lens package 250 to assist or encourage the user's wearing of the lenses. The lens package 250 may include a plastic base 252 with multiple rounded depressions 254 and 256, where an individual compartment holds an individual lens, and removable cover portions 258 (e.g., a continuous aluminum foil with perforations that separate individual compartments, or separate aluminum foil portions for each compartment) attached to the plastic base 252 with a suitable adhesive. The package may be configured such that when the foil cover is adhered to the base 252, a depression 254, 256 forms a separate liquid-tight compartment for holding a single contact lens in sterile saline solution. As shown in FIG. 2B, the lens package 250 may include various different regions. The package 250 may include a region 260 for designating a day number, day of the week, or numerical sequence for assisting the wear with opening the proper compartments for a given period's usage. In the example of FIG. 2B, the period of usage of a given lens pair is 1 day, but other periods of usage for a given lens pair may be used, e.g., 1 day, 2 days, etc. Different portions of package may be separable by virtue of perforations formed in the base 252 shown by dotted lines in FIG. 2B, such that those portions may be separated from each other by tearing along the perforations, if desired.

The package 250 may also include a region 262 of left-eye lenses arranged along a column and a region 264 of right-eye lenses arranged along a column. Thus, each given row 266 of lenses may include a numerical designation for the time period (e.g., day number or day of the week) as well as a right lens and a left lens. In addition, in this example, the package 250 includes a region 265 that includes artwork for one period of use that is different from artwork for another period of use. In this example, days 1, 3 and 5 may include a first cartoon image (and optionally the name in text) for a first cartoon character, such as a mouse “Mickey”, and days 2, 4, and 6 may include a second cartoon image (and optionally the name in text) for a different second cartoon character, such as a mouse “Minnie.” The use of such artwork may assist young child users to distinguish between lens pairs to be worn on different days and may also encourage young child users to be more enthusiastic about adhering to the proper wear schedules.

Each row of lenses may be populated with the appropriate pair of prescription lenses for that time period. For example, the first row designated with the number “1” includes a left-eye lens of prescription 1L and a right-eye lens of prescription 1R. The second row designated with the number “2” includes a left-eye lens of prescription 2L and a right-eye lens of prescription 2R. In this example, those two prescriptions (1L/1R and 2L/2R) of lens pairs may then repeated to provide multiple first pair lenses and multiple second pair lenses. However, it will be appreciated that other configurations involving more than two pairs of lenses and/or involving different time periods for wear are possible. The lens package or kit 250 may also include an instruction insert 268, e.g., printed on paper, comprising written instructions for usage and wearing (e.g., guidelines for re-use and disposal, wearing times, etc.) In this example, the insert 268 may also include use of the above noted artwork in the use instructions.

In a variation of the example shown in FIG. 2B, distinguishing imagery could be used to assist users to distinguish between right-eye lenses and left-eye lenses. For example, the imagery (and optionally the text) for “Mickey” could be placed next to each left-eye lens, and the imagery (and optionally the text) for “Minnie” could be placed next to each right-eye lens.

Other embodiments are directed to an exemplary method for choosing corrective lenses for an individual that may inhibit progression of myopia. It will be appreciated that the corrective lenses in this regard may either be contact lenses of two or more prescriptions, or the corrective lenses may be spectacles of two or more prescriptions. In this regard, FIG. 3 illustrates an exemplary method 300 for choosing lenses for an individual. At step 302 eye measurement information is obtained about a person based on at least one measurement of the person's eyes. The information may be obtained by retrieving it from a data base or other record, or by carrying out the measurement itself. At step 304, a first prescription is identified for a first pair of lenses for the person using, at least in part, the eye measurement information of the person, the first pair of lenses comprising a first lens for the left eye and a first lens for the right eye. At step 306, a second prescription is identified for a second pair of lenses for the person using, at least in part, the eye measurement information of the person, the second pair of lenses comprising a second lens for the left eye and a second lens for the right eye. As previously discussed above, the first lens for the left eye and the second lens for the right eye may be configured to provide normal central vision correction. Also, the first lens for the right eye and the second lens for the left eye may be configured to not provide normal central vision correction or otherwise provide a refraction condition designed to exercise the eye and/or cause the eye to change shape overtime in a manner that may inhibit the progression of myopia. Considerations involved in choosing suitable prescriptions for the multiple pairs of lenses have been described above.

At step 308, a first time period is identified for the person to wear the first pair of lenses of the first prescription. At step 310, a second time period is identified for the person to wear the second pair of lenses. As noted above, these time periods may be, for instance, one day (e.g., the waking hours of the day), more than one day, or some portion of a day, such as 12 hours, 24 hours, 36 hours, 48 hours, 72 hours or combinations thereof. The first time period may be the same as the second time period or different from the second time period. At step 312, instructions are provided for the person for wearing the first pair of lenses of the first prescription for the first time period and the second pair of lenses of the second prescription for the second time period. These instructions can be provided, for example, in the form of written instructions accompanying the lens package or lens kit of lenses, such as described above in connection with FIGS. 2A and 2B.

Other embodiments are directed to a method for manufacturing a corrective lens kit for the eyes of an individual as shown in the example of FIG. 4. FIG. 4 illustrates an exemplary method 400 for affecting vision of the eyes, exercising the eyes, and/or inhibiting the progression of myopia for an individual. At step 402 a first pair of lenses of a first prescription is selected, wherein the first pair of lenses comprises a first lens for the left eye and a first lens for the right eye. At step 404, a second pair of lenses of a second prescription, wherein the second pair of lenses comprises a second lens for the left eye and a second lens for the right eye, and wherein the first prescription is different from the second prescription. At step 406, the first pair of lenses and the second pair of lenses are packaged together into a package of lenses comprising a plurality of compartments formed by a base and a removable cover, wherein an individual lens of the first and second pairs of lenses is disposed in an individual compartment in a sterile solution. The removable cover may be adapted to permit exposing a given lens individually without impairing a compartment of another lens. Exemplary aspects of a suitable package were described above in connection with FIGS. 2A and 2B. At step 408, a set of written instructions may be provided with the lens package for wearing the first pair of lenses of the first prescription for a first time period and the second pair of lenses of the second prescription for a second time period, such as previously described in connection with FIGS. 2A and 2B.

Other embodiments are directed to a method of affecting the vision of, or exercising, the eyes of an individual. In the exemplary method, the individual wears a pair of lenses of a first prescription proximate to a left eye and a right eye for a first time period, wherein the pair of lenses of the first prescription comprising a first lens for the left eye and a first lens for the right eye such as described above. Thereafter, the individual wears a pair of lenses of a second prescription proximate to the left eye and the right eye for a second time period, wherein the second prescription is different from the first prescription. The pair of lenses of the second prescription comprises a second lens for the left eye and a second lens for the right eye. Thereafter, the individual wears a pair of lenses of the first prescription (e.g., a fresh pair of unused contact lenses, or a cleaned pair of previously used lenses) proximate to the left eye and the right eye for another first time period. Thereafter, the individual wears a pair of lenses of the second prescription (e.g., a fresh pair of unused contact lenses, or a cleaned pair of previously used lenses) proximate to the left eye and the right eye for another second time period. Suitable lens configurations and prescriptions, and first and second time periods, may be chosen as described previously herein.

In the embodiments described herein, the first pair of lenses and the second pair of lenses may be contact lenses, or they may be spectacle lenses. In one or more of the combinations referred to herein, at least one of the first pair of lenses and the second pair lenses may be selected to reduce the rate of myopia progression. In one or more of the combinations referred to herein, at least one of the first pair of lenses and the second pair lenses may be selected to reduce the degradation of distance vision. In one or more of the combinations referred to herein, at least one of the first pair of lenses and the second pair lenses may be selected to reduce the rate of myopia progression and to reduce the degradation of distance vision. In one or more of the combinations referred to herein, at least one of the first lens for the left eye, the first lens for the right eye, the second lens for the left eye, and the second lens for the right eye may be a single vision lens. In one or more of the combinations referred to herein, at least one of the first lens for the left eye, the first lens for the right eye, the second lens for the left eye, and the second lens for the right eye may be a multifocal lens. In one or more of the combinations referred to herein, at least one of the first lens for the left eye, the first lens for the right eye, the second lens for the left eye, and the second lens for the right eye may be a single vision lens and at least one of the first lens for the left eye, the first lens for the right eye, the second lens for the left eye, and the second lens for the right eye may be a multifocal lens.

In one or more of the combinations referred to herein, the first pair of lenses may comprise a single vision lens for distance vision and a single vision lens for near vision. In one example, the first lens for the left eye may be a single vision lens for distance vision, the first lens for the right eye may be a single vision lens for near vision, the second lens for the left eye may be a single vision lens for near vision, and the second lens for the right eye may be a single vision lens for distance vision. In one or more of the combinations referred to herein, the first pair of lenses may comprise a single vision lens for distance vision and a single vision lens for intermediate vision. In one example, the first lens for the left eye may be a single vision lens for distance vision, the first lens for the right eye may be a single vision lens for intermediate vision, the second lens for the left eye may be a single vision lens for intermediate vision, and the second lens for the right eye may be a single vision lens for distance vision.

In one or more of the combinations referred to herein, the first pair of lenses may comprise a single vision lens for distance vision and a bifocal lens with a predetermined amount of effective ADD power. In one example, the first lens for the left eye may be a single vision lens for distance vision, the first lens for the right eye may be a conventional bifocal lens with a predetermined amount of effective ADD power, the second lens for the left eye may be a conventional bifocal lens with a predetermined amount of effective ADD power, and the second lens for the right eye may be a single vision lens for distance vision. In one or more of the combinations referred to herein, the first pair of lenses may comprise a single vision lens for distance vision and a conventional multifocal lens with a predetermined amount of effective ADD power. In one example, the first lens for the left eye may be a single vision lens for distance vision, the first lens for the right eye may be a conventional multifocal lens with a predetermined amount of effective ADD power, the second lens for the left eye may be conventional multifocal lens with a predetermined amount of effective ADD power, and the second lens for the right eye is a single vision lens for distance vision.

In one or more of the combinations referred to herein, the first pair of lenses may comprise a single vision lens for distance vision and a multifocal lens of TYPES I, II, III or IV as described above herein with a predetermined amount of effective ADD power. In one example, the first lens for the left eye may be a single vision lens for distance vision, the first lens for the right eye may be a multifocal lens of TYPES I, II, III or IV as described above herein with a predetermined amount of effective ADD power, the second lens for the left eye may be a multifocal lens of TYPES I, II, III or IV as described above herein with a predetermined amount of effective ADD power, and the second lens for the right eye may be a single vision lens for distance vision. In these examples, the effective ADD power may be one of 0.50 D, 1.00 D, 1.50 D, 2.00 D, 2.50 D, 3.00 D, 3.50 D or 4.00 D, or other suitable ADD power.

In one or more of the combinations referred to herein, the first time period may be different than the second time period, or the first time period may be the same as the second time period. For example, the first time period and the second time period may be about 12 hours, 24 hours, 48 hours or longer.

Additional examples are disclosed below for which various choices of lens prescriptions and time periods for wearing lenses of those prescriptions may be chosen as explained above.

### EXAMPLES

### Example A1

A method for choosing corrective lenses for the eyes of an individual, the method comprising:

obtaining eye measurement information about an individual based on at least one measurement of the individual's eyes;

identifying a first prescription for a first pair of lenses for the individual using, at least in part, the eye measurement information of the individual, the first pair of lenses comprising a first lens for the left eye and a first lens for the right eye;

identifying a second prescription for a second pair of lenses for the individual using, at least in part, the eye measurement information of the individual, the second pair of lenses comprising a second lens for the left eye and a second lens for the right eye;

identifying a first time period for the individual to wear the first pair of lenses;

identifying a second time period for the individual to wear the second pair of lenses;

wherein the first prescription is different from the second prescription.

### Example A2

A method of arranging a lens kit for the eyes of an individual, comprising:

selecting a first pair of lenses of a first prescription, the first pair of lenses comprising a first lens for the left eye and a first lens for the right eye;

selecting a second pair of lenses of a second prescription, the second pair of lenses comprising a second lens for the left eye and a second lens for the right eye;

packaging the first pair of lenses and the second pair of lenses together into a package of lenses comprising a plurality of compartments formed by a base and a removable cover, an individual lens of the first and second pairs of lenses being disposed in an individual compartment in a sterile solution, the removable cover being adapted to permit exposing a given lens individually without impairing a compartment of another lens; and

providing a set of written instructions for wearing the first pair of lenses of the first prescription for a first time period and the second pair of lenses of the second prescription for a second time period,

wherein the first prescription is different from the second prescription.

### Example A3

A method of affecting vision of the eyes of an individual, the method comprising:

wearing a pair of lenses of a first prescription proximate to a left eye and a right eye for a first time period, the pair of lenses of the first prescription comprising a first lens for the left eye and a first lens for the right eye;

thereafter, wearing a pair of lenses of a second prescription proximate to the left eye and the right eye for a second time period, the second prescription being different from the first prescription, the pair of lenses of the second prescription comprising a second lens for the left eye and a second lens for the right eye;

thereafter, wearing a pair of lenses of the first prescription proximate to the left eye and the right eye for another first time period; and

thereafter, wearing a pair of lenses of the second prescription proximate to the left eye and the right eye for another second time period.

### Example A4

A method for choosing lenses for inhibiting myopia progression of the eyes of an individual, the method comprising:

obtaining eye measurement information about an individual based on at least one measurement of the individual's eyes;

identifying a first prescription for a first pair of lenses for the individual using, at least in part, the eye measurement information of the individual, the first pair of lenses comprising a first lens for the left eye and a first lens for the right eye;

identifying a second prescription for a second pair of lenses for the individual using, at least in part, the eye measurement information of the individual, the second pair of lenses comprising a second lens for the left eye and a second lens for the right eye;

identifying a first time period for the individual to wear the first pair of lenses; and

identifying a second time period for the individual to wear the second pair of lenses,

wherein the first prescription is different from the second prescription.

### Example A5

A method of arranging a lens kit for inhibiting myopia progression of the eyes of an individual, comprising:

selecting a first pair of lenses of a first prescription, the first pair of lenses comprising a first lens for the left eye and a first lens for the right eye;

selecting a second pair of lenses of a second prescription, the second pair of lenses comprising a second lens for the left eye and a second lens for the right eye;

packaging the first pair of lenses and the second pair of lenses together into a package of lenses comprising a plurality of compartments formed by a base and a removable cover, an individual lens of the first and second pairs of lenses being disposed in an individual compartment in a sterile solution, the removable cover being adapted to permit exposing a given lens individually without impairing a compartment of another lens; and

providing a set of written instructions for wearing the first pair of lenses of the first prescription for a first time period and the second pair of lenses of the second prescription for a second time period,

wherein the first prescription is different from the second prescription.

### Example A6

A combination of a first pair of lenses and a second pair of lenses for an individual, the first pair of lenses having a first prescription for the individual and comprising a first lens for the left eye and a first lens for the right eye, the second pair of lenses having a second prescription for the individual and comprising a second lens for the left eye and a second lens for the right eye, the first prescription being different from the second prescription, the combination of the first prescription and the second prescription having effective amounts of optical correction to inhibit myopia progression of the eyes of the individual, comprising administering of the combination of the first pair of lenses and the second pair of lenses for the individual.

### Example A7

The method of one or more preceding A Examples, wherein the first pair of lenses and the second pairs of lenses are configured for inhibiting a progression of myopia when worn according to the first time period and the second time period, respectively.

### Example A8

The method of one or more preceding A Examples, wherein the first lens for the left eye and the second lens for the right eye are configured to provide normal central vision correction, and wherein the first lens for the right eye and the second lens for the left eye are configured to not provide normal central vision correction.

### Example A9

The method of one or more preceding A Examples, wherein the first lens for the left eye and the second lens for the right eye are configured to provide normal central vision correction, and wherein the first lens for the right eye and the second lens for the left eye are configured to provide peripheral image points that are not focused on the retinas the right and the left eyes in peripheral region outside the foveas of the right and left eyes such that image points are disposed predetermined distances away from the retinas.

### Example A10

The method of one or more preceding A Examples, wherein the first pair of lenses and the second pair of lenses are contact lenses.

### Example A11

The method of one or more preceding A Examples, wherein the first pair of lenses and the second pair of lenses are spectacle lenses.

### Example A12

The method of one or more preceding A Examples, wherein at least one of the first pair of lenses and the second pair lenses is selected to reduce the rate of myopia progression.

### Example A13

The method of one or more preceding A Examples, wherein at least one of the first pair of lenses and the second pair lenses is selected to reduce the degradation of distance vision.

### Example A14

The method of one or more preceding A Examples, wherein at least one of the first pair of lenses and the second pair lenses is selected to reduce the rate of myopia progression and to reduce the degradation of distance vision.

### Example A15

The method of one or more preceding A Examples, wherein at least one of the first lens for the left eye, the first lens for the right eye, the second lens for the left eye, and the second lens for the right eye is a single vision lens.

### Example A16

The method of one or more of A Examples 1-15, wherein the first pair of lenses comprises a single vision lens for distance vision and a single vision lens for near vision.

### Example A17

The method of one or more of A Examples 1-15, wherein the first lens for the left eye is a single vision lens for distance vision and the first lens for the right eye is a single vision lens for near vision, and the second lens for the left eye is a single vision lens for near vision and the second lens for the right eye is a single vision lens for distance vision.

### Example A18

The method of one or more of A Examples 1-15, wherein the first pair of lenses comprises a single vision lens for distance vision and a single vision lens for intermediate vision.

### Example A19

The method of one or more of A Examples 1-15, wherein the first lens for the left eye is a single vision lens for distance vision and the first lens for the right eye is a single vision lens for intermediate vision, and the second lens for the left eye is a single vision lens for intermediate vision and the second lens for the right eye is a single vision lens for distance vision.

### Example A20

The method of one or more of A Examples 1-15, wherein the first pair of lenses comprises a single vision lens for distance vision and a bifocal lens with a predetermined amount of ADD power.

### Example A21

The method of one or more of A Examples 1-15, wherein the first lens for the left eye is a single vision lens for distance vision and the first lens for the right eye is a bifocal lens with a predetermined amount of ADD power, and the second lens for the left eye is a bifocal lens with a predetermined amount of ADD power and the second lens for the right eye is a single vision lens for distance vision.

### Example A22

The method of one or more of A Examples 1-15, wherein at least one of the first lens for the left eye, the first lens for the right eye, the second lens for the left eye, and the second lens for the right eye is a multifocal lens.

### Example A23

The method of one or more of A Examples 1-15, wherein at least one of the first lens for the left eye, the first lens for the right eye, the second lens for the left eye, and the second lens for the right eye is a single vision lens, and at least one of the first lens for the left eye, the first lens for the right eye, the second lens for the left eye, and the second lens for the right eye is a multifocal lens.

### Example A24

The method of one or more of A Examples 1-15, wherein the first pair of lenses comprises a single vision lens for distance vision and a multifocal lens with a predetermined amount of ADD power.

### Example A25

The method of one or more of A Examples 1-15, wherein the first lens for the left eye is a single vision lens for distance vision and the first lens for the right eye is multifocal lens with a predetermined amount of ADD power, and the second lens for the left eye is multifocal lens with a predetermined amount of ADD power and the second lens for the right eye is a single vision lens for distance vision.

### Example A26

The method of one or more of A Examples 1-15, wherein the first pair of lenses comprises a single vision lens for distance vision and multifocal lens having a non-monotonic radial power profile and a predetermined amount of ADD power.

### Example A27

The method of one or more preceding A Examples, wherein the second pair of lenses comprises a single vision lens for distance vision and multifocal lens having a non-monotonic radial power profile and a predetermined amount of ADD power.

### Example A28

The method of one or more of A Examples 1-15, wherein the first lens for the left eye is a single vision lens for distance vision and the first lens for the right eye is multifocal lens having a non-monotonic radial power profile and a predetermined amount of ADD power, and the second lens for the left eye is multifocal lens having a non-monotonic radial power profile and a predetermined amount of ADD power, and the second lens for the right eye is a single vision lens for distance vision.

### Example A29

The method of one or more of A Examples 20, 21 and 24-27, wherein the ADD power is one of 0.50 D, 1.00 D, 1.50 D, 2.00 D, 2.50 D, 3.00 D, 3.50 D or 4.00 D.

### Example A30

The method of one or more preceding A Examples, wherein a power profile is associated with the optical axis of at least one of the lenses of the first pair and the power profile has a transition between a maxima and a minima, and the maxima is within 0.2 mm of the centre of the optic zone and the minima is less than or equal to 0.3, 0.6, 0.9 or 1 mm distance from the maxima; wherein the amplitude of the transition between the maxima and the minima is at least 2.5 D, 4 D, 5 D or 6 D.

### Example A31

The method of Example A30, wherein the transition between the maxima and the minima of the at least one lenses is one or more of the following: continuous, discontinuous, monotonic and non-monotonic.

### Example A32

The method of one or more preceding A Examples, wherein at least one of the lenses has an optical axis and an aberration profile about its optical axis, the aberration profile: having a focal distance; and including higher order aberrations having at least one of a primary spherical aberration component C(4,0) and a secondary spherical aberration component C(6,0), wherein the aberration profile provides, for a model eye with no aberrations, or substantially no aberrations, and an on-axis length equal to, or substantial equal to, the focal distance: a retinal image quality (RIQ) with a through focus slope that degrades in a direction of eye growth; and a RIQ of at least 0.3 wherein the RIQ is visual Strehl Ratio measured substantially along the optical axis for at least one pupil diameter in the range 3 mm to 6 mm, over a spatial frequency range of 0 to 30 cycles/degree inclusive and at a wavelength selected from within the range 540 nm to 590 nm inclusive.

### Example A33

The method of Example A32, wherein the higher order aberrations of the at least one lenses includes at least three spherical aberration terms selected from the group C(4,0) to C(20,0).

### Example A34

The method of one of more preceding A examples, further comprising providing instructions for the individual for wearing the first pair of lenses of the first prescription for the first time period and the second pair of lenses of the second prescription for the second time period,

### Example A35

The method of one or more preceding A Examples, wherein the first time period is different than the second time period.

### Example A36

The method of one or more preceding A Examples, wherein the first time period is the same as the second time period.

### Example A37

The method of one or more preceding A Examples, wherein the first time period and the second time period are about 12 hours.

### Example A38

The method of one or more preceding A Examples, wherein the first time period and the second time period are about 24 hours.

### Example A39

The method of one or more preceding A Examples, wherein the first time period and the second time period are about 48 hours.

### Example B1

A corrective lens system for the eyes of an individual, the system comprising:

a first pair of lenses of a first prescription, the first pair of lenses comprising a first lens for the left eye and a first lens for the right eye;

a second pair of lenses of a second prescription, the second pair of lenses comprising a second lens for the left eye and a second lens for the right eye,

the first pair of lenses and the second pair of lenses being arranged in a package comprising a plurality of compartments formed by a base and a removable cover, an individual lens of the first and second pairs of lenses being disposed in an individual compartment in a sterile solution, the removable cover adapted to permit exposing a given lens individually without impairing the compartment for another lens; and

a set of written instructions for wearing the first pair of lenses of the first prescription for a first time period and the second pair of lenses of the second prescription for a second time period,

wherein the first prescription is different from the second prescription.

### Example B2

A lens system for inhibiting myopia progression of the eyes of an individual, the system comprising:

a first pair of lenses of a first prescription, the first pair of lenses comprising a first lens for the left eye and a first lens for the right eye;

a second pair of lenses of a second prescription, the second pair of lenses comprising a second lens for the left eye and a second lens for the right eye,

the first pair of lenses and the second pair of lenses being arranged in a package comprising a plurality of compartments formed by a base and a removable cover, an individual lens of the first and second pairs of lenses being disposed in an individual compartment in a sterile solution, the removable cover adapted to permit exposing a given lens individually without impairing the compartment for another lens; and

a set of written instructions for wearing the first pair of lenses of the first prescription for a first time period and the second pair of lenses of the second prescription for a second time period,

wherein the first prescription is different from the second prescription.

### Example B3

The system of one or more preceding B Examples, wherein the first pair of lenses and the second pairs of lenses are configured for inhibiting a progression of myopia when worn according to the first time period and the second time period, respectively.

### Example B4

The system of one or more preceding B Examples, wherein the first lens for the left eye and the second lens for the right eye are configured to provide normal central vision correction, and wherein the first lens for the right eye and the second lens for the left eye are configured to not provide normal central vision correction.

### Example B5

The system of one or more preceding B Examples, wherein the first lens for the left eye and the second lens for the right eye are configured to provide normal central vision correction, and wherein the first lens for the right eye and the second lens for the left eye are configured to provide peripheral image points that are not focused on the retinas the right and the left eyes in peripheral region outside the foveas of the right and left eyes such that image points are disposed predetermined distances away from the retinas.

### Example B6

The system of one or more preceding B Examples, wherein the first pair of lenses and the second pair of lenses are contact lenses.

### Example B7

The system of one or more preceding B Examples, wherein the first pair of lenses and the second pair of lenses are spectacle lenses.

### Example B8

The system of one or more preceding B Examples, wherein at least one of the first pair of lenses and the second pair lenses is selected to reduce the rate of myopia progression.

### Example B9

The system of one or more preceding B Examples, wherein at least one of the first pair of lenses and the second pair lenses is selected to reduce the degradation of distance vision.

### Example B10

The system of one or more preceding B Examples, wherein at least one of the first pair of lenses and the second pair lenses is selected to reduce the rate of myopia progression and to reduce the degradation of distance vision.

### Example B11

The system of one or more preceding B Examples, wherein at least one of the first lens for the left eye, the first lens for the right eye, the second lens for the left eye, and the second lens for the right eye is a single vision lens.

### Example B12

The system of one or more of B Examples 1-5, wherein the first pair of lenses comprises a single vision lens for distance vision and a single vision lens for near vision.

### Example B13

The system of one or more of B Examples 1-5, wherein the first lens for the left eye is a single vision lens for distance vision and the first lens for the right eye is a single vision lens for near vision, and the second lens for the left eye is a single vision lens for near vision and the second lens for the right eye is a single vision lens for distance vision.

### Example B14

The system of one or more of B Examples 1-5, wherein the first pair of lenses comprises a single vision lens for distance vision and a single vision lens for intermediate vision.

### Example B15

The system of one or more of B Examples 1-5, wherein the first lens for the left eye is a single vision lens for distance vision and the first lens for the right eye is a single vision lens for intermediate vision, and the second lens for the left eye is a single vision lens for intermediate vision and the second lens for the right eye is a single vision lens for distance vision.

### Example B16

The system of one or more of B Examples 1-5, wherein the first pair of lenses comprises a single vision lens for distance vision and a bifocal lens with a predetermined amount of ADD power.

### Example B17

The system of one or more of B Examples 1-5, wherein the first lens for the left eye is a single vision lens for distance vision and the first lens for the right eye is a bifocal lens with a predetermined amount of ADD power, and the second lens for the left eye is a bifocal lens with a predetermined amount of ADD power and the second lens for the right eye is a single vision lens for distance vision.

### Example B18

The system of one or more of B Examples 1-5, wherein at least one of the first lens for the left eye, the first lens for the right eye, the second lens for the left eye, and the second lens for the right eye is a multifocal lens.

### Example B19

The system of one or more of B Examples 1-5, wherein at least one of the first lens for the left eye, the first lens for the right eye, the second lens for the left eye, and the second lens for the right eye is a single vision lens, and at least one of the first lens for the left eye, the first lens for the right eye, the second lens for the left eye, and the second lens for the right eye is a multifocal lens.

### Example B20

The system of one or more of B Examples 1-5, wherein the first pair of lenses comprises a single vision lens for distance vision and a multifocal lens with a predetermined amount of ADD power.

### Example B21

The system of one or more of B Examples 1-5, wherein the first lens for the left eye is a single vision lens for distance vision and the first lens for the right eye is multifocal lens with a predetermined amount of ADD power, and the second lens for the left eye is multifocal lens with a predetermined amount of ADD power and the second lens for the right eye is a single vision lens for distance vision.

### Example B22

The system of one or more of B Examples 1-5, wherein the first pair of lenses comprises a single vision lens for distance vision and multifocal lens having a non-monotonic radial power profile and a predetermined amount of ADD power.

### Example B23

The system of one or more preceding B Examples, wherein the second pair of lenses comprises a single vision lens for distance vision and multifocal lens having a non-monotonic radial power profile and a predetermined amount of ADD power.

### Example B24

The system of one or more of B Examples 1-5, wherein the first lens for the left eye is a single vision lens for distance vision and the first lens for the right eye is multifocal lens having a non-monotonic radial power profile and a predetermined amount of ADD power, and the second lens for the left eye is multifocal lens having a non-monotonic radial power profile and a predetermined amount of ADD power, and the second lens for the right eye is a single vision lens for distance vision.

### Example B25

The system of one or more of B Examples 16, 17 and 19-24, wherein the ADD power is one of 0.50 D, 1.00 D, 1.50 D, 2.00 D, 2.50 D, 3.00 D, 3.50 D or 4.00 D.

### Example B26

The system of one or more preceding B Examples, wherein a power profile is associated with the optical axis of at least one of the lenses of the first pair and the power profile has a transition between a maxima and a minima, and the maxima is within 0.2 mm of the centre of the optic zone and the minima is less than or equal to 0.3, 0.6, 0.9 or 1 mm distance from the maxima; wherein the amplitude of the transition between the maxima and the minima is at least 2.5 D, 4 D, 5 D or 6 D.

### Example B27

The system of Example B26, wherein the transition between the maxima and the minima of the at least one lenses is one or more of the following: continuous, discontinuous, monotonic and non-monotonic.

### Example B28

The system of one or more preceding B Examples, wherein at least one of the lenses has an optical axis and an aberration profile about its optical axis, the aberration profile: having a focal distance; and including higher order aberrations having at least one of a primary spherical aberration component C(4,0) and a secondary spherical aberration component C(6,0), wherein the aberration profile provides, for a model eye with no aberrations, or substantially no aberrations, and an on-axis length equal to, or substantial equal to, the focal distance: a retinal image quality (RIQ) with a through focus slope that degrades in a direction of eye growth; and a RIQ of at least 0.3 wherein the RIQ is visual Strehl Ratio measured substantially along the optical axis for at least one pupil diameter in the range 3 mm to 6 mm, over a spatial frequency range of 0 to 30 cycles/degree inclusive and at a wavelength selected from within the range 540 nm to 590 nm inclusive.

### Example B29

The system of Example B28, wherein the higher order aberrations of the at least one lenses includes at least three spherical aberration terms selected from the group C(4,0) to C(20,0).

### Example B30

The system of one or more preceding B Examples, wherein the first time period is different than the second time period.

### Example B31

The system of one or more preceding B Examples, wherein the first time period is the same as the second time period.

### Example B32

The system of one or more preceding B Examples, wherein the first time period and the second time period are about 12 hours.

### Example B33

The system of one or more preceding B Examples, wherein the first time period and the second time period are about 24 hours.

### Example B34

The system of one or more preceding B Examples, wherein the first time period and the second time period are about 48 hours.

While exemplary embodiments have been shown and described herein, it will be appreciated by those skilled in the art that such embodiments are provided by way of example only. It is intended that the following claims define the scope of the invention and that methods and structures within the scope of these claims and their equivalents are to be covered thereby.

1. A method for choosing corrective lenses for the eyes of an individual, the method comprising:
obtaining eye measurement information about an individual based on at least one measurement of the individual's eyes;
identifying a first prescription for a first pair of lenses for the individual using, at least in part, the eye measurement information of the individual, the first pair of lenses comprising a first lens for the left eye and a first lens for the right eye;
identifying a second prescription for a second pair of lenses for the individual using, at least in part, the eye measurement information of the individual, the second pair of lenses comprising a second lens for the left eye and a second lens for the right eye;
identifying a first time period for the individual to wear the first pair of lenses; and
identifying a second time period for the individual to wear the second pair of lenses,
wherein the first prescription is different from the second prescription.

2. A method of arranging a lens kit for the eyes of an individual, comprising:
selecting a first pair of lenses of a first prescription, the first pair of lenses comprising a first lens for the left eye and a first lens for the right eye;
selecting a second pair of lenses of a second prescription, the second pair of lenses comprising a second lens for the left eye and a second lens for the right eye;
packaging the first pair of lenses and the second pair of lenses together into a package of lenses comprising a plurality of compartments formed by a base and a removable cover, an individual lens of the first and second pairs of lenses being disposed in an individual compartment in a sterile solution, the removable cover being adapted to permit exposing a given lens individually without impairing a compartment of another lens; and
providing a set of written instructions for wearing the first pair of lenses of the first prescription for a first time period and the second pair of lenses of the second prescription for a second time period,
wherein the first prescription is different from the second prescription.

3. The method of claim 1, wherein the first pair of lenses and the second pairs of lenses are configured for inhibiting a progression of myopia when worn according to the first time period and the second time period, respectively.

4. The method of claim 1, wherein the first lens for the left eye and the second lens for the right eye are configured to provide normal central vision correction, and wherein the first lens for the right eye and the second lens for the left eye are configured to not provide normal central vision correction.

5. The method of claim 1, wherein the first lens for the left eye and the second lens for the right eye are configured to provide normal central vision correction, and wherein the first lens for the right eye and the second lens for the left eye are configured to provide peripheral image points that are not focused on the retinas of the right and the left eyes in a peripheral region outside the foveas of the right and left eyes such that image points are disposed predetermined distances away from the retinas.

6. The method of claim 1, wherein the first pair of lenses and the second pair of lenses are contact lenses.

7. The method of claim 1, wherein the first pair of lenses and the second pair of lenses are spectacle lenses.

8. The method of claim 1, wherein at least one of the first pair of lenses and the second pair lenses is selected to reduce the rate of myopia progression.

9. The method of claim 1, wherein at least one of the first pair of lenses and the second pair lenses is selected to reduce the degradation of distance vision.

10. The method of claim 1, wherein the first pair of lenses comprises a single vision lens for distance vision and a bifocal lens with a predetermined amount of ADD power.

11. The method of claim 1, wherein at least one of the first lens for the left eye, the first lens for the right eye, the second lens for the left eye, and the second lens for the right eye is a multifocal lens.

12. The method of claim 1, wherein the first pair of lenses comprises a single vision lens for distance vision and a multifocal lens with a predetermined amount of ADD power.

13. The method of claim 1, wherein the first lens for the left eye is a single vision lens for distance vision and the first lens for the right eye is multifocal lens with a predetermined amount of ADD power, and the second lens for the left eye is multifocal lens with a predetermined amount of ADD power and the second lens for the right eye is a single vision lens for distance vision.

14. The method of claim 1, wherein the first pair of lenses comprises a single vision lens for distance vision and multifocal lens having a non-monotonic radial power profile and a predetermined amount of ADD power.

15. The method of claim 1, wherein the first lens for the left eye is a single vision lens for distance vision and the first lens for the right eye is multifocal lens having a non-monotonic radial power profile and a predetermined amount of ADD power, and the second lens for the left eye is multifocal lens having a non-monotonic radial power profile and a predetermined amount of ADD power, and the second lens for the right eye is a single vision lens for distance vision.

16. The method of claim 1, wherein a power profile is associated with the optical axis of at least one of the lenses of the first pair and the power profile has a transition between a maxima and a minima, and the maxima is within 0.2 mm of the centre of the optic zone and the minima is less than or equal to 0.3, 0.6, 0.9 or 1 mm distance from the maxima; wherein the amplitude of the transition between the maxima and the minima is at least 2.5 D, 4 D, 5 D or 6 D.

17. The method of claim 1, wherein at least one of the lenses has an optical axis and an aberration profile about its optical axis, the aberration profile having a focal distance and including higher order aberrations having at least one of a primary spherical aberration component C(4,0) and a secondary spherical aberration component C(6,0), wherein, for a model eye with no aberrations, or substantially no aberrations, and an on-axis length equal to, or substantial equal to, the focal distance, the aberration profile provides:
a retinal image quality (RIQ) with a through focus slope that degrades in a direction of eye growth; and
a RIQ of at least 0.3 wherein the RIQ is visual Strehl Ratio measured substantially along the optical axis for at least one pupil diameter in the range 3 mm to 6 mm, over a spatial frequency range of 0 to 30 cycles/degree inclusive and at a wavelength selected from within the range 540 nm to 590 nm inclusive.

18. The method of claim 1, wherein the first time period is different than the second time period.

19. The method of claim 1, wherein the first time period and the second time period are about 12 hours, 24 hours or 48 hours.

20. A corrective lens system for the eyes of an individual, the system comprising:
a first pair of lenses of a first prescription, the first pair of lenses comprising a first lens for the left eye and a first lens for the right eye;
a second pair of lenses of a second prescription, the second pair of lenses comprising a second lens for the left eye and a second lens for the right eye,
the first pair of lenses and the second pair of lenses being arranged in a package comprising a plurality of compartments formed by a base and a removable cover, an individual lens of the first and second pairs of lenses being disposed in an individual compartment in a sterile solution, the removable cover adapted to permit exposing a given lens individually without impairing the compartment for another lens; and
a set of written instructions for wearing the first pair of lenses of the first prescription for a first time period and the second pair of lenses of the second prescription for a second time period,
wherein the first prescription is different from the second prescription.

21. The system of claim 20, wherein the first pair of lenses and the second pairs of lenses are configured for inhibiting a progression of myopia when worn according to the first time period and the second time period, respectively.

22. The system of claim 20, wherein the first lens for the left eye and the second lens for the right eye are configured to provide normal central vision correction, and wherein the first lens for the right eye and the second lens for the left eye are configured to not provide normal central vision correction.

23. The system of claim 20, wherein the first pair of lenses and the second pair of lenses are contact lenses.

24. The system of claim 20, wherein the first lens for the left eye is a single vision lens for distance vision and the first lens for the right eye is multifocal lens having a non-monotonic radial power profile and a predetermined amount of ADD power, and the second lens for the left eye is multifocal lens having a non-monotonic radial power profile and a predetermined amount of ADD power, and the second lens for the right eye is a single vision lens for distance vision.

25. The system of claim 20, wherein a power profile is associated with the optical axis of at least one of the lenses of the first pair and the power profile has a transition between a maxima and a minima, and the maxima is within 0.2 mm of the centre of the optic zone and the minima is less than or equal to 0.3, 0.6, 0.9 or 1 mm distance from the maxima; wherein the amplitude of the transition between the maxima and the minima is at least 2.5 D, 4 D, 5 D or 6 D.
